(19) United States
(12) Patent Application Publication
(10) Pub. No.: US 2024/0074506 A1
(43) Pub. Date: Mar. 7, 2024

(54) HEATER ELEMENT

(71) Applicant: NICOVENTURES TRADING LIMITED, London (GB)

(72) Inventor: Julian WHITE, Cambridgeshire (GB)

(21) Appl. No.: 18/262,977

(22) PCT Filed: Feb. 2, 2022
(86) PCT No.: PCT/EP2022/052399

§ 371 Date: Jul. 26, 2023

(30) Foreign Application Priority Data
Feb. 3, 2021 (GB) 2101464.2

(51) Int. Cl. A24F 40/465; A24F 40/70

(52) U.S. Cl. CPC A24F 40/465; A24F 40/70

(57) ABSTRACT

A heater element for an aerosol provision device is disclosed. The heater element includes a support and heating material that is heatable by penetration with a varying magnetic field, wherein the heating material includes an electroless plating on the support.

### PRIORITY CLAIM

The present application is a National Phase entry of PCT Application No. PCT/EP2022/052399, filed Feb. 2, 2022, which claims priority from GB Application No. 2101464.2, filed Feb. 3, 2021, each of which is hereby fully incorporated herein by reference.

### TECHNICAL FIELD

The present disclosure relates to a heater element, a method for forming a heater element, an aerosol provision device, and an aerosol provision system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure there is provided a heater element for an aerosol provision device, the heater element comprising a support and heating material that is heatable by penetration with a varying magnetic field, wherein the heating material comprises an electroless plating on the support.

The support may comprise a non-electrically conductive material. The support may comprise a polymer, for example a polyimide, such as Zytel® high temperature nylon (HTN) or Kapton®.

The support may comprise a material with a melting point greater than 300° C. The support may comprise polyether ether ketone (PEEK).

The heating material may comprise at least one of nickel and cobalt.

The heating material may comprise a thickness of no more than 100 microns in a direction orthogonal to a surface of the support. The heating material may comprise a thickness of no more than 50 microns, no more than 20 microns, or no more than 10 microns, in a direction orthogonal to a surface of the support. The heating material may comprise a thickness of around 15 microns where the liner comprises nickel, or around 10 microns where the heating material comprises cobalt.

The support may comprise a tubular support. For example, the support may be hollow and comprise open longitudinal ends which allow insertion of a consumable therethrough.

The heating material may be disposed on a radially inwardly facing face of the support.

The heater element may comprise a further heating material attached to the heating material, the further heating material comprising a different material to the heating material, the heating material disposed between the further heating material and the support.

The further heating material may be heatable by penetration with a varying magnetic field. The further heating material may comprise any or any combination of aluminum, gold, iron, nickel, cobalt, conductive carbon, graphite, plain-carbon steel, stainless steel, terrific stainless steel, copper, and bronze.

The heater element may comprise a plurality of regions of the heating material, the plurality of regions spaced apart on the support. The plurality of regions may be evenly spaced apart on the support.

The heater element may be to define a chamber for receiving a consumable comprising aerosol-generating material when the heater element is located within the aerosol provision device.

The heater element may comprise a heater element for use in an aerosol provision device comprising a chamber and a heating assembly for applying heat to a consumable comprising aerosol-generating material to generate aerosol from the aerosol-generating material when the consumable is located in the chamber, the heater element for selective insertion into the chamber to at least partially line the chamber.

The heater element may be formable into a first configuration in which the heater element is wound with a first diameter, and formable into a second configuration in which the heater element is wound with a second diameter greater than the first diameter, the heater element movable from the first configuration to the second configuration when inserted into the chamber to at least partially line the chamber.

An outer surface of the heater element may define a substantially cylindrical shape in the first configuration, for example having the first diameter. An outer surface of the heater element may define a substantially cylindrical shape in the second configuration, for example having the second diameter.

The first diameter may comprise a largest distance between two opposing points on an outwardly facing face, for example a radially outwardly facing face, of the heater element in the first configuration. The second diameter may comprise a largest distance between two opposing points on an outwardly facing face, for example a radially outwardly facing face, of the liner in the second configuration.

The heater element may comprise first and second free ends, one of the first and second free ends wound toward the other of the first and second free ends to obtain the first configuration. One of the first and second free ends may be at least partially wound toward the other of the first and second free ends in the second configuration.

The first and second free ends may be overlapping in the first configuration. The heater element may comprise an outwardly facing face and an inwardly facing face in the first configuration, for example a radially outwardly facing face and a radially inwardly facing face, the outwardly facing face and the inwardly facing face extending between the first and second free ends, and the first and second free ends may overlap in the first configuration such that the outwardly facing face and the inwardly facing face overlap in the first configuration. The outwardly facing face may contact the inwardly facing face in the first configuration.

The first and second free ends may be substantially contiguous or overlapping in the second configuration, for example such that the heater element fully lines a circumferential extent of the chamber when inserted into the chamber and in the second configuration. The heater element may comprise an outwardly facing face and an inwardly facing face in the second configuration, the outwardly facing face and the inwardly facing face extending between the first and second free ends, and the first and second free ends may overlap in the second configuration such that the outwardly facing face and the inwardly facing face overlap in the second configuration. The outwardly facing face may contact the inwardly facing face in the second configuration.

The first and second free ends may be spaced apart in the second configuration, for example such that the heater element partially lines the circumferential extent of the chamber when inserted into the chamber and in the second configuration. The first and second free ends may be spaced apart in the second configuration such that the outwardly facing face and the inwardly facing face do not overlap in the second configuration.

The heater element may comprise a scroll shape when viewed in a direction along a longitudinal axis of the liner in the first configuration. The heater element may comprise a scroll shape or a circular shape when viewed in a direction along a longitudinal axis of the liner in the second configuration. The heater element may be elongate in form in the first and second configurations, for example having a length greater than its diameter in the first and second configurations.

The second diameter may be in the region of 5.0-6.0 mm, for example in the region of 5.3-5.7 mm. The second diameter may be in the region of 6.5-7.5 mm, for example in the region of 6.7-7.3 mm. The second diameter may be substantially equal to a diameter of the chamber.

The heater element may be expandable by at least partial unwinding when inserted into the chamber to move from the first configuration to the second configuration.

The heater element may comprise open longitudinal ends in the first and second configurations.

The heater element may be resiliently deformable.

According to a second aspect of the present disclosure there is provided an aerosol provision device comprising a heater element for applying heat to a consumable comprising aerosol-generating material to generate aerosol from the aerosol-generating material, the heater element comprising a support and heating material that is heatable by penetration with a varying magnetic field, wherein the heating material comprises an electroless plating on the support, and the heater element at least partially defines a chamber into which the consumable is insertable to be heated by the heating material.

The heater element may be tubular in form, for example with the support comprising a tubular support.

The heating material may be provided on a radially inwardly facing face of the heater element, for example such that the heating material at least partially defines the chamber. The heating material may be provided on a radially inwardly facing face of the support.

According to a third aspect of the present disclosure there is provided an aerosol provision system comprising a chamber, a heating assembly for applying heat to a consumable comprising aerosol-generating material to generate aerosol from the aerosol-generating material when the consumable is located in the chamber, and a heater element according to the first aspect of the present disclosure.

According to a fourth aspect of the present disclosure there is provided a method for forming a heater element for an aerosol provision device, the method comprising; providing a support; and electrolessly plating heating material onto the support, the heating material heatable by penetration with a varying magnetic field.

The support may comprise a non-electrically conductive material.

The method may comprise electrolessly plating the heating material on a radially inwardly facing face of the support.

The method may comprise attaching a further heating material to the heating material, the further heating material comprising a different material to the first heating material, the heating material disposed between the further heating material and the support.

The method may comprise masking a portion of the support prior to the electroless plating.

Further features and advantages of the disclosure will become apparent from the following description of various embodiments of the disclosure, given by way of example only, which is made with reference to the accompanying drawings.

### BRIEF DESCRIPTION OF THE DRAWINGS

FIG. 1 is a schematic illustration of an aerosol provision device according to an example.

FIG. 2a is a schematic cross-sectional view of a portion of the aerosol provision device of FIG. 1.

FIG. 2b is a schematic cross-sectional view illustrating a heater element of the aerosol provision device of FIG. 1.

FIG. 3 is a flow diagram illustrating a method of forming a heater element of the aerosol provision device of FIG. 1.

FIG. 4 is a schematic view illustrating a heater element according to an example.

FIG. 5 is a flow diagram illustrating a method of forming the heater element of FIG. 4.

FIG. 6 is a schematic cross-sectional view of a heater element according to an example.

FIG. 7 is a flow diagram illustrating a method of forming the heater element of FIG. 6.

FIG. 8a is a schematic view of a liner for use with the aerosol provision device of FIG. 1.

FIG. 8b is a schematic view of the liner of FIG. 8a in a first configuration.

FIG. 8c is a schematic view of the liner of FIG. 8a in a second configuration.

FIG. 8d is a schematic view of the liner of FIG. 8a in an alternative second configuration.

FIG. 9a is a schematic view of a first retention member for use with the liner of FIG. 8a.

FIG. 9b is a schematic view of a second retention member for use with the liner of FIG. 8a.

FIG. 10 is a schematic view of a liner according to an example.

FIG. 11 is a schematic view of a liner according to an example.

### DETAILED DESCRIPTION OF THE DRAWINGS

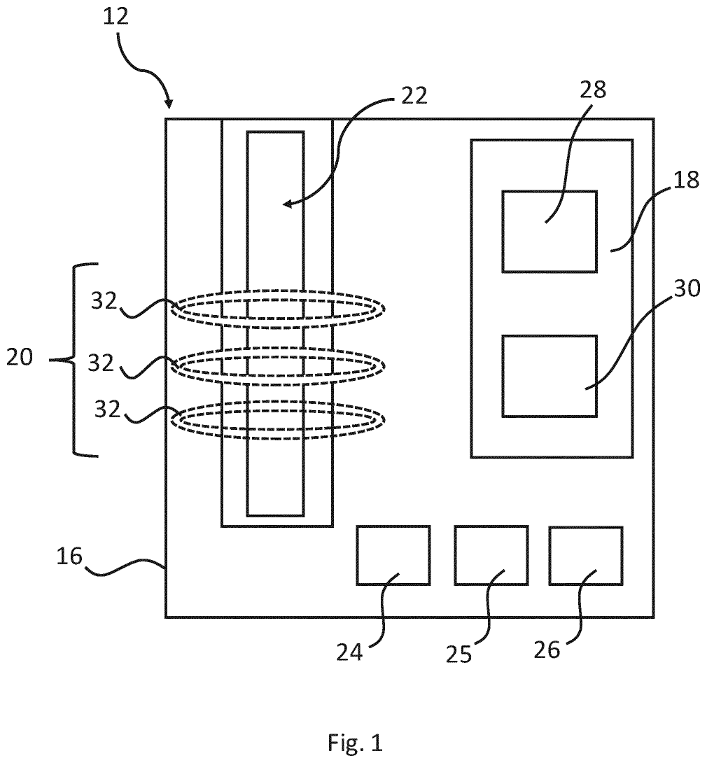

An aerosol provision device according to an example of the present disclosure, generally designated 12, is shown schematically in FIG. 1.

The aerosol provision device 12 comprises a housing 16, a power source 18, a heating assembly 20, a chamber 22, a processor 24, a computer readable memory 25, and a user-operable control element 26.

The housing 16 forms an outer cover of the aerosol provision device 12 and surrounds and houses the various components of the aerosol provision device 12.

The power source 18 supplies electrical power to the various components of the aerosol provision device 12, including, for example, the heating assembly 20. In the embodiment of FIG. 1, the power source 18 comprises a battery 28 and a DC-AC converter 30 to supply AC current to the heating assembly 20. It will be appreciated that, in alternative embodiments, a heating assembly 20 may require DC current, and so the DC-AC converter 30 may be omitted or be replaced by a DC-DC converter, for example a buck or boost converter, as appropriate.

The aerosol provision device 12 may also comprise an electrical component, such as a socket/port (not shown), which can receive a cable to charge the battery 28. For example, the socket may comprise a charging port, such as a USB charging port. In some examples the socket may be used additionally or alternatively to transfer data between the aerosol provision device 12 and another device, such as a computing device. The socket may also be electrically coupled to the battery 28 via electrical tracks.

The processor 24 is in data communication with the computer readable memory 25. The processor 24 is configured to control various aspects of the operation of the aerosol provision device 12. The processor 24 controls the various aspects by executing instructions stored on the computer readable memory 25. For example, the processor 24 may control the operation of the heating assembly 20. For example, the processor may control the delivery of electrical power from the power source 18 to the heating assembly 20 by controlling various electrical components such as switches and the like (not shown in FIG. 1).

The user-operable control element 26 is, for example, a button or switch, which operates the aerosol provision device 12 when pressed. For example, a user may turn on the aerosol provision device 12 by operating the user-operable control element 26, or may alter a setting of the heating assembly 20 by operating the user-operable control element 26.

The heating assembly 20 of FIG. 1 is an induction heating assembly, and comprises a plurality of heating coils 32. The plurality of heating coils 32 are individually controllable, are spaced along the chamber 22, and are configured to interact with a susceptor 34 which will be described hereinafter.

A susceptor is a material that is heatable by penetration with a varying magnetic field, such as an alternating magnetic field. The susceptor may be an electrically conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically conductive and magnetic, so that the susceptor is heatable by both heating mechanisms.

To cause heating of the chamber 22, and therefore heating of a consumable received within the chamber 22, the DC-AC converter 30 supplies the plurality of heating coils 32 with AC current, such that the plurality of heating coils 32 generate a varying magnetic field. The varying magnetic field interacts with the susceptor 34 to drive eddy currents within the susceptor 34, with the flow of eddy currents causing heating of the susceptor 34.

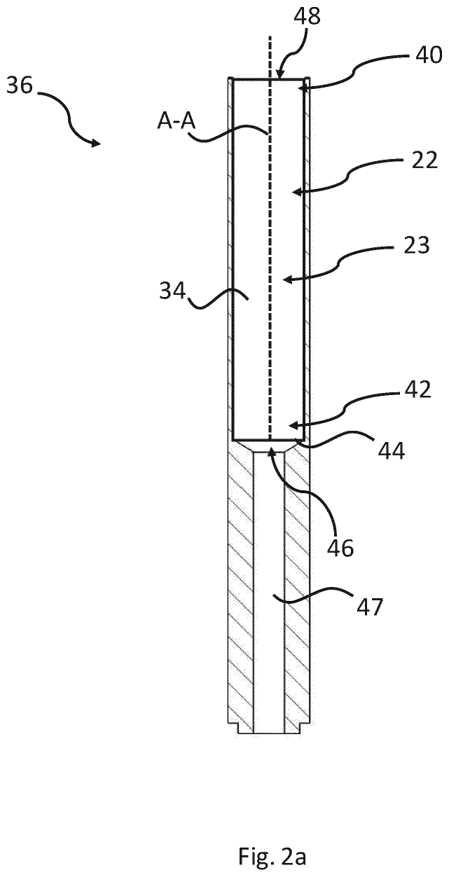

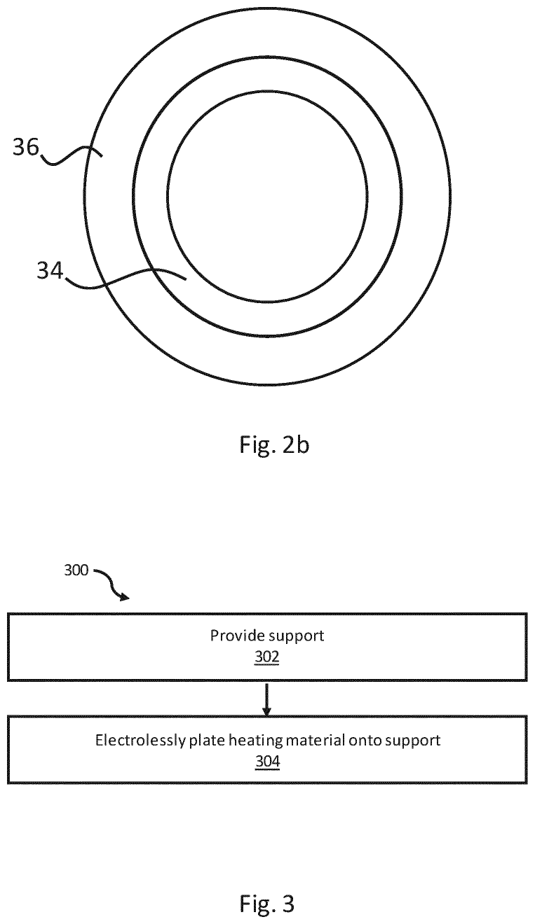

The chamber 22 is defined by a generally hollow tubular member 36, as seen in cross-section in FIG. 2a. The tubular member 36 comprises an elongate hollow body. Internal walls of the tubular member 36 define the chamber 22, with the chamber 22 having a proximal end 40 and a distal end 42. The extent of the chamber 22 between the proximal end 40 and the distal end 42 may be referred to as a main portion 23 of the chamber 22. The distal end 42 comprises a tapered wall 44, which is tapered toward central axis A-A of the chamber 22. An aperture 46 in the tapered wall 44 is in fluid communication with an air inlet 47 of the aerosol provision device 12.

The proximal end 40 of the chamber 22 comprises an opening 48 through which a consumable (not shown in FIG. 2a) is insertable into the chamber 22.

To avoid deformation of the tubular member 36 due to heat in use, the tubular member 36 is formed from a material with a melting point greater than 300° C., and in the example of FIG. 2a is formed from PEEK. The material of the tubular member 36 is also a non-electrically conductive material to avoid the generation of eddy currents therein due to interaction with magnetic fields produced by the plurality of coils 32, and hence to avoid heating of the tubular member 36 by induction heating in use.

In use the chamber 22 is configured to accommodate, one at a time, consumables comprising aerosol-generating material, with the heating assembly 20 being used to generate aerosol from the aerosol-generating material to be inhaled by a user. The chamber 22 may therefore be considered a heating chamber.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor. Such consumables are typically elongate and generally cylindrical.

As consumables are intended to be inserted into the chamber 22 in use, and the chamber 22 is intended to be utilized as a heating chamber, it is desirable to locate the susceptor 34 in the vicinity of the chamber 22.

In the embodiment of FIGS. 2a and 2b, the susceptor 34 is provided as a layer of heating material that has been plated onto the internal walls of the tubular member 36 by electroless plating. By heating material is meant a material that is heatable by penetration with a varying magnetic field, i.e. heatable as part of an induction heating process. The heating material in the examples of FIGS. 2a and 2b is either nickel or cobalt. Collectively the combination of the susceptor 34 and the tubular member 36 may be thought of as a heater element for the aerosol provision device 12. The susceptor 34 may also be thought of as a wall of the chamber 22 in such an example.

Electroless plating is a chemical process that deposits an even layer of metallic material on the surface of a solid substrate, like metal or plastic. For nickel-phosphorous electroless plating, the process involves dipping the substrate in a water solution containing nickel salt and a phosphorus-containing reducing agent, usually a hypophosphite salt. Electroless plating processes in general do not require passing an electric current through the bath and the substrate, and the reduction of the metal cations in solution to metallic is achieved by purely chemical means, through an autocatalytic reaction. Thus electroless plating may create an even layer of metal regardless of the geometry of the surface, and can be applied to non-electrically-conductive surfaces.

Electroless plating in the context of the present disclosure may thereby provide an even layer of heating material on the interior of the tubular member 36, which may provide a susceptor 34 of substantially constant thickness. This may provide improved heating properties in use, for example with more even heating along the length of the susceptor 34 and within the chamber 22. Electroless plating may also allow the metallic susceptor 34 to be located on the plastic tubular member 36 without need for, for example, an adhesive, which may otherwise increase a distance from the susceptor 34 to the plurality of coils 32, thereby negatively impacting heating in use by increasing a distance between the susceptor 34 and the plurality of coils 32.

For conductive (and magnetizable) media such as the heating material there is a characteristic depth (the “skin depth”) into which the electromagnetic field is able to penetrate. The thickness of the heating material forming the susceptor 34 is thus at least some significant fraction of the skin depth for the material at the working frequency of the induction system. For example, a thickness of one or more skin depths should help to ensure that a majority of the available energy is directed into the heating material forming the susceptor 34. In some examples, the heating material has a thickness of no more than 100 microns, no more than 50 microns, or no more than 20 microns measured in a direction orthogonal to the plastic tubular member 36. Where the heating material comprises nickel, the thickness of the heating material may be around 15 microns. Where the heating material comprises cobalt, the thickness of the heating material may be around 10 microns.

A method 300 for forming the heater element for the aerosol provision device 12 is illustrated in the flow diagram of FIG. 3. The method 300 comprises providing 302 a support in the form of the tubular member 36, and electrolessly plating 304 heating material in the form of the susceptor 34 onto the tubular member 36.

As shown in FIGS. 2a and 2b, the susceptor 34 is provided by electroless plating along substantially the entire length of the chamber 22, as well as substantially the entire circumferential extent of the chamber 22.

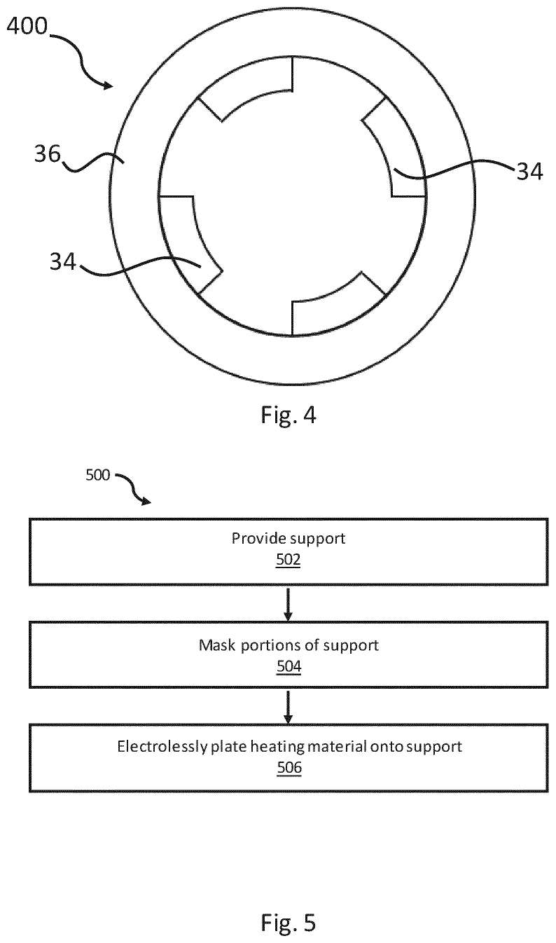

In other examples, as shown schematically in FIG. 4, the susceptor 34 is provided by electroless plating of nickel or cobalt onto a plurality of regions of the interior of the tubular member 36, with the regions spaced circumferentially on the tubular member 36. Again, collectively the susceptor 34 and the tubular member 36 define a heater element 400. The regions which do not comprise the susceptor 34 are masked off with wax during the plating process. By providing a plurality of regions the susceptor 34 is provided only where needed, which may provide improved heating characteristics compared to, for example, an arrangement where the susceptor 34 extends about the full circumferential extent of the tubular member 36.

A method 500 of forming the heater element 400 of FIG. 4 is illustrated in the flow diagram of FIG. 5. The method 500 comprises providing 502 a support in the form of the tubular member 36, and masking 504 a plurality of portions of the tubular member 36. The method 500 comprises electrolessly plating 506 heating material in the form of the susceptor 34 onto the tubular member 36 in the regions which are not masked.

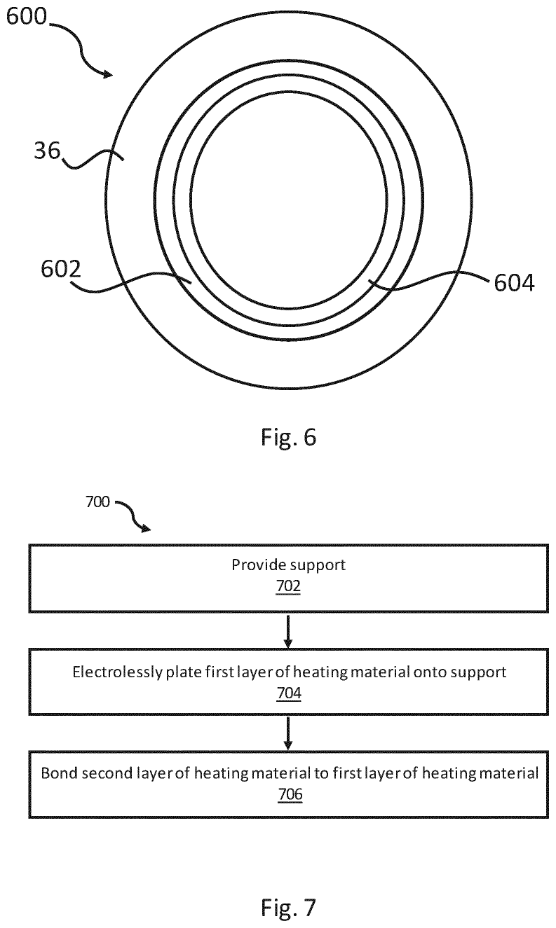

Another form of heater element 600 is shown schematically in cross-section in FIG. 6. Here the heater element comprises the tubular member 36 as a support, a first layer of heating material 602, and a second layer of heating material 604. Collectively the first 602 and second 604 layers of heating material define the susceptor 34.

The first layer of heating material 602 comprises one of nickel or cobalt, and the second layer of heating material 604 comprises one or more materials from the list of aluminum, gold, iron, conductive carbon, graphite, plain-carbon steel, stainless steel, terrific stainless steel, copper, and bronze. The first layer 602 of heating material is electrolessly plated onto the tubular member 36, as previously described. The second layer of heating material 604 may comprise improved inductive heating characteristics compared to the first layer of heating material 602, and may be attached to the first layer of heating material 602 by any appropriate method of bonding.

A method 700 of forming the heater element 600 of FIG. 6 is illustrated in the flow diagram of FIG. 7. The method 700 comprises providing 702 a support in the form of the tubular member 36, and electrolessly plating 704 a first layer of heating material 602 onto the tubular member 36. The method 700 comprises 706 bonding a second layer of heating material 604 onto the tubular member 36.

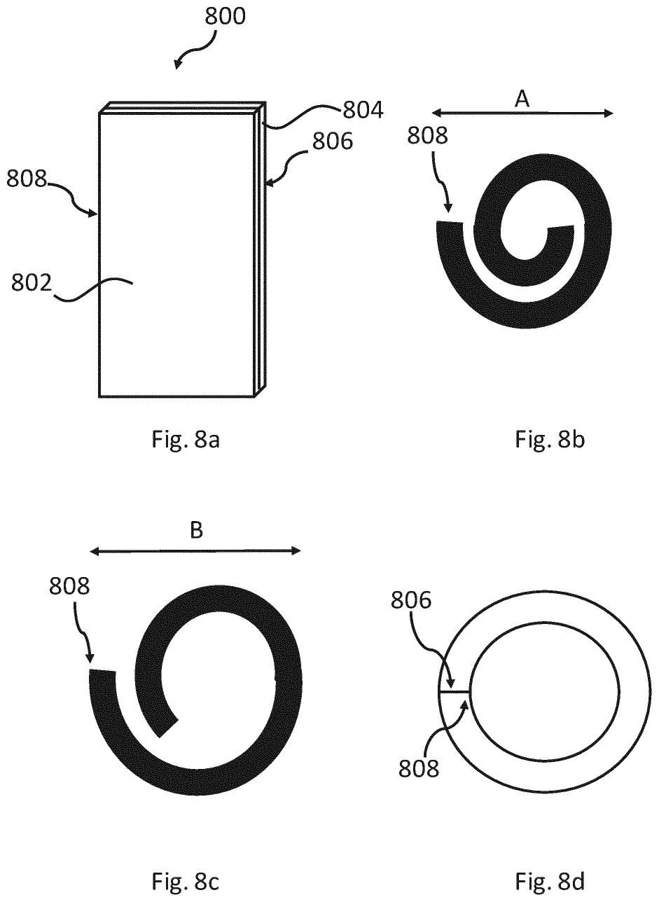

As previously described, the combination of the tubular member 36 and the susceptor 34 have defined a heater element, with the tubular member 36 and the susceptor defining the chamber 22 within which a consumable is received in use. In alternative embodiments, the tubular member 36 may still define the chamber 22, but a heater element may be provided as a removable liner 800, as illustrated schematically in FIGS. 8a-d, for selective insertion into the chamber 22.

The liner 800 comprises a support layer 802 which is a rectangular sheet of high-heat resistant polymer, for example a polyimide, such as Zytel® high temperature nylon (HTN) or Kapton®. Such materials may be considered non-electrically conductive, and may be resistant to the formation of eddy currents therein. The liner 800 comprises a layer of heating material 804, which is either nickel or cobalt, and which has been electrolessly plated onto the support layer 802 in the manner previously described.

The liner 800 is resiliently deformable, and comprises first 806 and second 808 free ends. The rectangular shape of the liner 800 shown in FIG. 8a may, in some examples, be thought of as a rest configuration for the liner 800.

The liner 800 is formable into a first configuration as shown in FIG. 8b, and a second configuration as shown in FIG. 8c. The interface between the support layer 802 and the layer of heating material 804 is not shown in FIGS. 8b and 8c for the sake of clarity. The thickness or material of the layers 802, 804 may be chosen to enable the liner 800 to be formed into the first configuration of FIG. 8b, and either of the second configurations of FIGS. 8c and 8d. The layer of heating material 804 is located such that it forms an inwardly facing face of the liner 800 in the first configuration and the second configuration.

In the first configuration of FIG. 8b, the first free end 806 has been wound toward the second free end 808 such that the liner 800 has been formed, for example rolled-up, with the liner 800 having the scroll-shape seen in FIG. 8b, which is a view in a direction parallel to a longitudinal extent of the first 806 and second 808 free ends. The liner 800 in the first configuration has a generally cylindrical shape with a first diameter A. The first diameter A is a maximal distance between two opposing points on the support layer 802 of the liner 800 in the first configuration. The support layer 802 of the liner 800 overlaps the layer of heating material 804 of the liner 800 in the first configuration of FIG. 8b to give the scroll-shape.

In the second configuration of FIG. 8c, the first free end 806 has been unwound relative to the first configuration of FIG. 3b, with the liner 800 retaining the scroll-shape of FIG. 8b but less tightly wound. The first configuration may therefore be thought of as being partially unwound to achieve the second configuration. The liner 800 in the second configuration has a generally cylindrical shape with a second diameter B, with the second diameter B being greater than the first diameter A. The second diameter B is a maximal distance between two opposing points on the support layer 802 of the liner 800 in the second configuration. The support layer 802 of the liner 800 overlaps the layer of heating material 804 of the liner 800 in the second configuration of FIG. 8c to retain the scroll-shape.

In use, the liner 800 is first wound into the first configuration of FIG. 8b, before being inserted into the chamber 22. Once the liner 800 is released by a user, the resiliently deformable nature of the liner 800 causes the liner 800 to partially unwind from the first configuration to adopt the second configuration of FIG. 8c. The second diameter B of the second configuration of the liner 800 is substantially equal to a diameter of the chamber 22, and, due to the scroll-shape of the configuration of FIG. 8c, the liner 800 lines an entire circumferential extent of the chamber 22. The open longitudinal ends of the liner 800 allow a consumable to be inserted into the liner 800, and hence into the chamber 22 through the opening 48.

When inserted in the chamber 22 in such a fashion, the liner 800 may prevent build-up of deposits on the wall of the chamber 22 caused by side stream from the consumable when heated, with the liner 800 being removable and replaceable as needed. This may provide a convenient way to protect the wall of the chamber 22, whilst providing ease of use and reduced maintenance of the aerosol provision device 12 itself for a user. The overlap of the liner 800 in the second configuration of FIG. 8c may ensure that the full circumferential extent of the wall of the chamber 22 is protected, and the overlap may even go so far as to define a labyrinth seal to prevent egress of side stream from the liner 800.

It will be appreciated by a person skilled in the art that the extent to which the liner 800 is able to unwind from the first configuration to the second configuration may be determined by many factors, including, but not limited to, initial dimensions of the liner 800, a material of the liner 800, and a dimension of the chamber 22, for example a diameter of the chamber 22. In some examples these factors may lead to an alternative second configuration for the liner 800.

One such alternative second configuration for the liner 800 is shown in FIG. 8d. In the configuration of FIG. 8d, the liner 800 has unwound to such an extent that the first 806 and second 808 free ends are substantially contiguous. In such an embodiment, there is no overlap between the support layer 802 and the layer of heating material 804. Here the liner 800 has a generally cylindrical form with a substantially circular cross-sectional shape, and such a configuration may still be thought of as wound in view of the relative location of the first 806 and second 808 free ends.

Whilst the liner 800 was shown in FIG. 8a as initially having the form of a rectangular sheet, the liner 800 may be provided to a consumer, i.e. a user, of the aerosol provision device 12, in a pre-wound configuration, for example the first configuration of FIG. 8b or the second configuration of FIG. 8c.

In some examples, the material of the liner 800 may be chosen such that the liner 800 is capable of retaining the liner in a wound configuration, for example in the second configuration of FIG. 8c. Here the liner 800 may be formed into the first configuration of FIG. 8b by tighter winding pre-insertion into the chamber 22, then inserted into the chamber 22, and allowed to unwind to assume the second configuration of FIG. 8c upon release by the user.

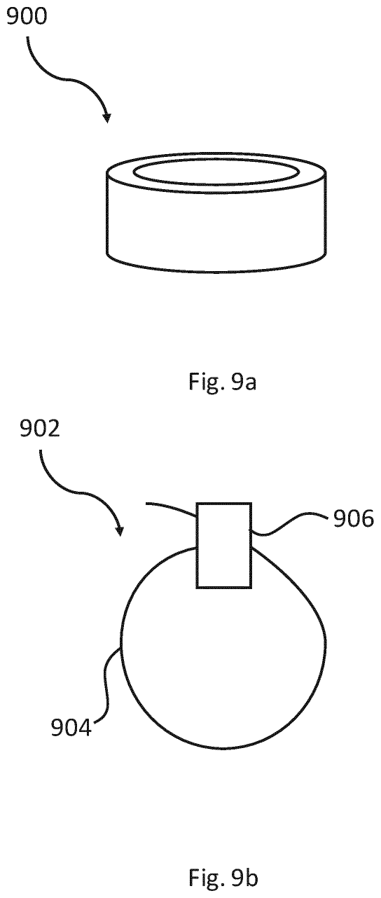

In other examples, the liner 800 may comprise a retention member for retaining the liner 800 in the first configuration. One such retention member 900 as shown in FIG. 9a, is a simple annular ring of relatively rigid material having an inner diameter substantially corresponding to the diameter A of the liner 800 in the first configuration of FIG. 8b. The retention member 900 of FIG. 9a may be simply removed from the liner 800 during insertion to the chamber 22 to allow unwinding of the liner 800 from the first configuration of FIG. 8b to either of the second configurations of FIGS. 8c and 8d.

A second embodiment of retention member 902 is shown in FIG. 9b. Here the retention member 902 comprises a strip 904 and a clamp 906 that can selectively retain the strip 904 in an annular arrangement of varying diameter. Such a retention member 902 may be similar to a jubilee clip, for example. Engagement of the clamp 906 with the strip 904 can be varied to enable the liner to move between the first configuration of FIG. 8b and either of the second configurations of FIGS. 8c and 8d, as desired.

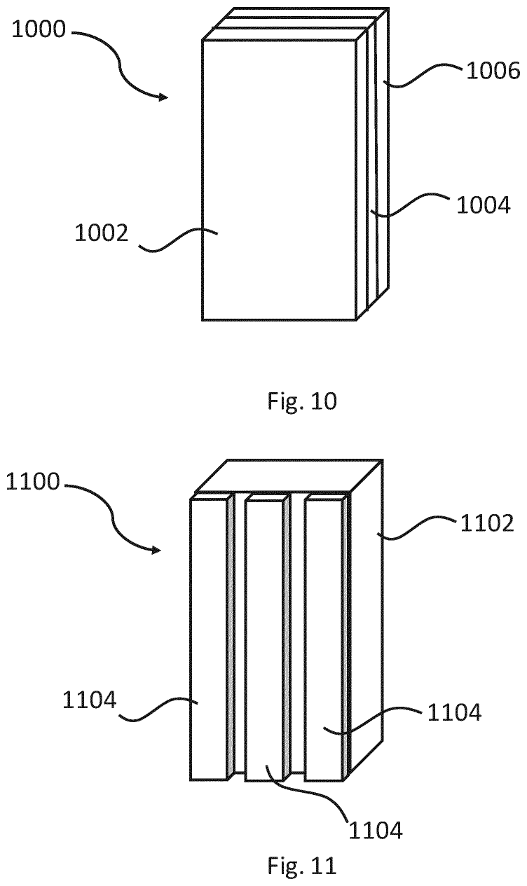

An alternative embodiment of liner 1000 is illustrated schematically in FIG. 10. The liner 1000 comprises a first layer 1002 of high-heat resistant polymer, a second layer 1004 of heating material, and a third layer of heating material 1006. The second layer of heating material 1004 comprises one of nickel or cobalt, and the third layer of heating material 1006 comprises one or more materials from the list of aluminum, gold, iron, conductive carbon, graphite, plain-carbon steel, stainless steel, terrific stainless steel, copper, and bronze. The second layer 1004 of heating material is electrolessly plated onto the first layer 1002 of high-heat resistant polymer, as previously described. The third layer of heating material 1006 may comprise improved inductive heating characteristics compared to the second layer of heating material 1004, and may be attached to the second layer of heating material 1006. by any appropriate method of bonding.

The liner 1000 of FIG. 10 may be formable into the configurations of FIGS. 8a-d, as previously described.

A further alternative embodiment of liner 1100 is illustrated schematically in FIG. 11. The liner 1100 comprises a support layer 1102 which is a rectangular sheet of high-heat resistant polymer, for example a polyimide, such as Zytel® high temperature nylon (HTN) or Kapton®. Such materials may be considered non-electrically conductive, and may be resistant to the formation of eddy currents therein. The liner 1100 comprises a plurality of regions 1104 of heating material, which is either nickel or cobalt, and which has been electrolessly plated onto the support layer 1102 in the manner previously described. Regions intermediate the plurality of regions 1104 of heating material are masked with wax during the electroless plating process. Use of a plurality of regions 1104 may assist with deformability of the liner 1100, and may facilitate movement between the first and second configurations previously described.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the claims. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A heater element for an aerosol provision device, the heater element comprising:
a support; and
heating material that is heatable by penetration with a varying magnetic field, wherein the heating material comprises an electroless plating on the support.

2. The heater element as claimed in claim 1, wherein the support comprises a non-electrically conductive material.

3. The heater element as claimed in claim 1, wherein the support comprises a material with a melting point greater than 300° C.

4. The heater element as claimed in claim 1, wherein the heating material comprises at least one of nickel or cobalt.

5. The heater element as claimed in claim 1, wherein the heating material comprises a thickness of no more than 100 microns in a direction orthogonal to a surface of the support.

6. The heater element as claimed in claim 1, wherein the support comprises a tubular support.

7. The heater element as claimed in claim 1, wherein the heating material is disposed on a radially inwardly facing face of the support.

8. The heater element as claimed in claim 1, wherein the heater element comprises a further heating material attached to the heating material, the further heating material comprising a different material than the heating material, the heating material disposed between the further heating material and the support.

9. The heater element as claimed in claim 8, wherein the further heating material comprises any, or any combination of aluminum, gold, iron, nickel, cobalt, conductive carbon, graphite, plain-carbon steel, stainless steel, ferritic stainless steel, copper, or bronze.

10. The heater element as claimed in claim 1, wherein the heater element comprises a plurality of regions of the heating material, the plurality of regions spaced apart on the support.

11. The heater element as claimed in claim 1, wherein the heater element defines a chamber for receiving a consumable comprising aerosol-generating material when the heater element is located within the aerosol provision device.

12. The heater element as claimed in claim 1, wherein the heater element comprises a heater element for use in an aerosol provision device comprising a chamber and a heating assembly for applying heat to a consumable comprising aerosol-generating material to generate aerosol from the aerosol-generating material when the consumable is located in the chamber, and wherein the heater element is for selective insertion into the chamber to at least partially line the chamber.

13. The heater element as claimed in claim 12, wherein the heater element is formable into a first configuration in which the heater element is wound with a first diameter, and formable into a second configuration in which the heater element is wound with a second diameter greater than the first diameter, the heater element movable from the first configuration to the second configuration when inserted into the chamber to at least partially line the chamber.

14. The heater element as claimed in claim 13, wherein the heater element is expandable by at least partial unwinding when inserted into the chamber to move from the first configuration to the second configuration.

15. The heater element as claimed in claim 13, wherein the heater element comprises open longitudinal ends in the first configuration and the second configuration.

16. The heater element as claimed in claim 12, wherein the heater element is resiliently deformable.

17. An aerosol provision device comprising:
a heater element for applying heat to a consumable comprising aerosol-generating material to generate aerosol from the aerosol-generating material, the heater element comprising:
a support, and
heating material that is heatable by penetration with a varying magnetic field,
wherein the heating material comprises an electroless plating on the support;
wherein the heater element at least partially defines a chamber into which a consumable is insertable to be heated by the heating material.

18. An aerosol provision system comprising a chamber, a heating assembly for applying heat to a consumable comprising aerosol-generating material to generate aerosol from the aerosol-generating material when the consumable is located in the chamber, and the heater element as claimed in claim 12.

19. A method for forming a heater element for an aerosol provision device, the method comprising;
providing a support; and
electrolessly plating heating material onto the support, the heating material heatable by penetration with a varying magnetic field.

20-23. (canceled)

24. The method as claimed in claim 19, further comprising electrolessly plating the heating material on a radially inwardly facing face of the support.

25. The method as claimed in claim 19, further comprising attaching a further heating material to the heating material, the further heating material comprising a different material than the first heating material, the heating material disposed between the further heating material and the support.

26. (canceled)

27. (canceled)

28. The method as claimed in claim 19, further comprising masking a portion of the support prior to the electroless plating.
